(19) United States
(12) Patent Application Publication
(10) Pub. No.: US 2011/0113632 A1
(43) Pub. Date: May 19, 2011

(54) Three-head electric shaver

(75) Inventor: Chengcong Bao, Shanghai (CN)

(73) Assignee: Shanghai Zhenbo Electric Co., Ltd.

(21) Appl. No.: 12/693,450

(22) Filed: Jan. 26, 2010

(30) Foreign Application Priority Data
Nov. 19, 2009 (CN) 200920213898.5

(51) Int. Cl. B26B 19/20; B26B 19/28

(52) U.S. Cl. 30/43; 30/45

(57) ABSTRACT

A three-head electric shaver includes a shaving body having a casing at a top end thereof, a switch, a power supply, an electric motor having a motor shaft; and three shaving heads spacedly aligned with each other and provided at an upper portion of the shaving body. Each of the three shaving heads is positioned at an arc of the upper portion of the shaving body. The present invention includes a cutter head support connected with the casing, wherein each of the three shaving heads is mounted thereon. Furthermore, each of the three shaving heads includes an outer foil and an inner blade, each of the three shaving heads is provided on a resilient piece. The present invention has an advantage of wider shaving range to save shaving time.

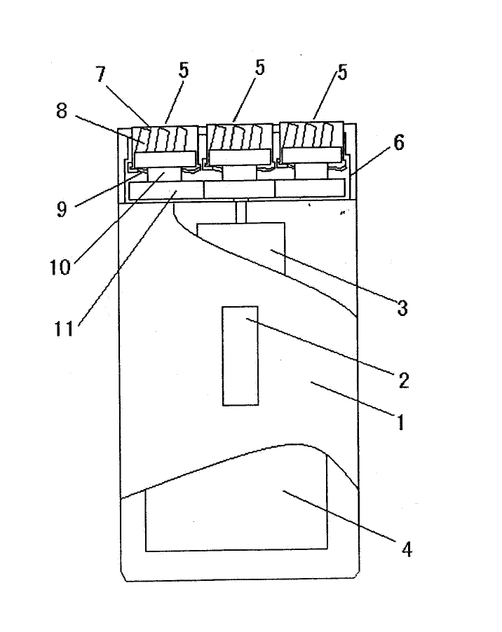

### BACKGROUND OF THE PRESENT INVENTION

1. Field of Invention

The present invention relates to an electric shaver, and more particularly to a three-head electric shaver.

2. Description of Related Arts

With the development of economy and improvement of people's living standard, most of the men have used the electric shavers. The electric shavers currently used are manufactured with three shaving heads arranged triangularly, or two shaving heads arranged side by side, or four shaving heads in a diamond-shaped or rectangle-shaped arrangement. However, the above mentioned electric shavers have a common shortcoming of smaller shaving areas, thus it is necessary to shave back and forth repeatedly on the face. Widening the scope of shaving will increase the cost and manufacturing difficulty. Accordingly, it is urgent to develop a new electric shaver with a wider shaving scope.

### SUMMARY OF THE PRESENT INVENTION

An object of the present invention is to resolve the problem of the narrow shaving scope of current electric shavers.

Accordingly, in order to accomplish the above object, the present invention provides a three-head electric shaver, comprising:

a shaving body having a casing at a top end thereof;

a switch received in the shaving body;

a power supply received in the shaving body;

an electric motor supported in the shaving body to electrically connect with the power supply, having a motor shaft; and

three shaving heads spacedly aligned with each other and provided at an upper portion of the shaving body.

These and other objectives, features, and advantages of the present invention will become apparent from the following detailed description, the accompanying drawings, and the appended claims.

### BRIEF DESCRIPTION OF THE DRAWINGS

The drawing is a perspective view of a three-head electric shaver according to a preferred embodiment of the present invention.

### DETAILED DESCRIPTION OF THE PREFERRED EMBODIMENT

Referring to the drawing, a three-head electric shaver according to a preferred embodiment of the present invention is illustrated. The three-head electric shaver comprises a shaving body 1, a switch 2, an electric motor 3, a battery 4, wherein the improvement of the present invention comprises three shaving heads 5 spacedly aligned with each other and provided at an upper portion of the shaving body 1, wherein each of the three shaving heads 5 is positioned at an arc of the upper portion of the shaving body 1. The improvement of the present invention comprises a cutter head support 6, wherein each of the three shaving heads 5 is mounted thereon, and the cutter head support 6 is connected with a casing at a top end of the shaving body 1. Furthermore, each of the three shaving heads 5 comprises an outer foil 7 and an inner blade 8, each of the three shaving heads 5 is provided on a resilient piece 9 of the cutter head support 6. The improvement of the present invention comprises three shafts 10 and three gears 11 engaged with the three shafts 10, respectively, wherein the inner blade 8 of each of the three shaving heads 5 are driven by each of the three shafts 10, and each of the three shafts 10 is connected with a motor shaft of the electric motor 3.

While using, the three shaving heads 5 can be spacedly aligned with each other, or spacedly arranged in an arc-shaped manner. Therefore, comparing with current other electric shavers, the shaving scope of the present invention will be wider. For the person with side-whiskers, pushing the electric shaver of the present invention once will shave a larger area of beard. Of course, if the person pushes longitudinally the electric shaver of the present invention, the three shaving heads 5 will shave the same place in turn, thus the side-whiskers difficult to be shaved will be shaved in a cleaner manner.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A three-head electric shaver, comprising:
a shaving body having a casing at a top end thereof;
a switch received in said shaving body;
a power supply received in said shaving body;
an electric motor supported in said shaving body to electrically connect with said power supply, having a motor shaft; and
three shaving heads spacedly aligned with each other and provided at an upper portion of said shaving body.

2. The three-head electric shaver, as recited in claim 1, wherein each of said three shaving heads is positioned at an arc of said upper portion of said shaving body.

3. The three-head electric shaver, as recited in claim 1, further comprising a cutter head support connected with said casing of said shaving body, wherein each of said three shaving heads is mounted on said cutter head support.

4. The three-head electric shaver, as recited in claim 2, further comprising a cutter head support connected with said casing of said shaving body, wherein each of said three shaving heads is mounted on said cutter head support.

5. The three-head electric shaver, as recited in claim 3, wherein said cutter head support comprises three resilient pieces, and said three shaving heads are provided on said three resilient pieces, respectively.

6. The three-head electric shaver, as recited in claim 4, wherein said cutter head support comprises three resilient pieces, and said three shaving heads are provided on said three resilient pieces, respectively.

7. The three-head electric shaver, as recited in claim 1, further comprising three shafts and three gears engaged with said three shafts, respectively, wherein each of said three shaving heads comprises an outer foil and an inner blade driven by each of said three shafts, and each of said three shafts is connected with said motor shaft of said electric motor.

8. The three-head electric shaver, as recited in claim 2, further comprising three shafts and three gears engaged with said three shafts, respectively, wherein each of said three shaving heads comprises an outer foil and an inner blade driven by each of said three shafts, and each of said three shafts is connected with said motor shaft of said electric motor.

9. The three-head electric shaver, as recited in claim 3, further comprising three shafts and three gears engaged with said three shafts, respectively, wherein each of said three shaving heads comprises an outer foil and an inner blade driven by each of said three shafts, and each of said three shafts is connected with said motor shaft of said electric motor.

10. The three-head electric shaver, as recited in claim 4, further comprising three shafts and three gears engaged with said three shafts, respectively, wherein each of said three shaving heads comprises an outer foil and an inner blade driven by each of said three shafts, and each of said three shafts is connected with said motor shaft of said electric motor.

11. The three-head electric shaver, as recited in claim 5, further comprising three shafts and three gears engaged with said three shafts, respectively, wherein each of said three shaving heads comprises an outer foil and an inner blade driven by each of said three shafts, and each of said three shafts is connected with said motor shaft of said electric motor.

12. The three-head electric shaver, as recited in claim 6, further comprising three shafts and three gears engaged with said three shafts, respectively, wherein each of said three shaving heads comprises an outer foil and an inner blade driven by each of said three shafts, and each of said three shafts is connected with said motor shaft of said electric motor.
